(19) United States
(12) Patent Application Publication
(10) Pub. No.: US 2025/0138255 A1
(43) Pub. Date: May 1, 2025

(54) MECHANISMS AND ASSEMBLIES FOR HOLDING A FIBER ACCESS UNIT IN A RECEPTACLE FOR CO-PACKAGED OPTICS

(71) Applicant: CORNING RESEARCH & DEVELOPMENT CORPORATION, CORNING, NY (US)

(72) Inventors: Andreas Matiss, Berlin (DE); Gordon Mueller-Schlomka, Berlin (DE); Eric Stephan ten Have, Berlin (DE)

(21) Appl. No.: 18/932,082

(22) Filed: Oct. 30, 2024

Related U.S. Application Data
(60) Provisional application No. 63/546,670, filed on Oct. 31, 2023.

(51) Int. Cl. G02B 6/40

(52) U.S. Cl. CPC G02B 6/403

(57) ABSTRACT

A mechanism for co-packaged optics includes a FAU and a bridge structure having at least one spring configured to exert a force on the FAU. In preferred configurations, the bridge structure includes at least one lifter that facilitates disengagement of the at least one spring. Holding mechanisms and assemblies for holding an FAU in a receptacle are also disclosed.

### PRIORITY APPLICATIONS

This application claims the benefit of priority of U.S. Provisional Application Ser. No. 63/546,670 filed on Oct. 31, 2023, the content of which is relied upon and incorporated herein by reference in its entirety.

### BACKGROUND

The present disclosure generally relates to mechanisms and assemblies for holding a fiber access unit (alternatively “FAU”) in a receptacle, particularly for co-packaged optics.

The growing demand for data and the challenges faced by data centers, such as reducing power consumption and cost per bit, have increased the significance of co-packaged optics (CPO). CPO, which involves integrating optical components and silicon photonics (SiP) on a single packaged substrate, holds great potential in addressing these challenges. In SiP, silicon is used as the optical medium, primarily in the near infrared (NIR) wavelength band around wavelengths of 1.31 μm and 1.55 μm, which are used in telecommunications. Advantages of SiP include the possibility of using existing semiconductor fabrication methods and infrastructure and the integration of electronics and photonics into a single chip as photonic integrated circuits (PICs) or at least into components that work closely together.

While progress has been made in developing components for CPO, the successful implementation of CPO also depends on the design and development of optical system solutions. Specifically, optimizing the complete optical system requires tailoring components and effectively managing and aligning fiber within the packaged substrate.

Managing waveguides plays a role in co-packaged optics. The fiber array unit (FAU), responsible for aligning fibers to waveguides is particularly important in CPO applications. Achieving low coupling losses requires tight positional tolerances and well-centered cores.

One known issue relates to the method of injecting or extracting light into/out of the SiP chips. In telecommunications, light is usually transported in fibers, which now have to be coupled to the SiP PICs. Here, three methods can be distinguished: Edge coupling—the waveguides of the SiP chip end and are interfaced with at the edge (side) of the SiP chip. Grating coupling—the PICs use grating couplers as an interface, where the light path is close to perpendicular to the surface of the chip. Grating couplers can be located anywhere on the chip's surface. Evanescent coupling—for evanescent coupling the waveguide in the silicon is brought into close proximity with a glass waveguide, so that the light can couple evanescently from the silicon to the glass and vice versa.

One of the difficulties with coupling light to SiP PICs is the difference in mode field diameters. Single mode fibers have a mode field diameter of about 10 μm, while modes in silicon waveguides may be of submicron dimensions because of the large refractive index of silicon (about 3.5), which leads to high losses if the fibers are coupled directly to the SiP waveguides. To reduce these losses, mode converters are required to scale the modes of the SiP to the size of the fiber modes.

While grating couplers can be designed such that they easily couple to single mode fibers, they have a limited bandwidth, so that they cannot support many different wavelengths (e.g., for WDM applications). Also, the fiber orientation perpendicular to the surface of the chip poses limits on the geometry/arrangements, in which these chips may be used.

Edge couplers require separate mode field converters to be able to couple to fibers. These may be realized in the silicon, as an additional interposer chip, where the conversion is realized through changing the waveguide size along the length, or through imaging optics.

With evanescent coupling, the mode field conversion can already be built into the geometry of the glass waveguides, to which fibers may then directly be coupled.

Accordingly, improved coupling methods and mechanisms and assemblies for holding an FAU in a receptacle, particularly for co-packaged optics, are needed.

### SUMMARY

Embodiments disclosed herein are directed to mechanisms, including receptacles for holding an FAU, particularly for co-packaged optics. Frequently, FAUs are directly glued to a corresponding surface or held by hinging covers. In some embodiments disclosed herein, aa holding mechanism is configured to extend across multiple SiP chips, allowing FAUs to be inserted and extracted individually.

Aspects of the embodiments disclosed herein pertain to mechanisms and assemblies for holding FAUs in receptacles. These mechanisms and assemblies can include several SiP chips, which are preferably arranged in a row. To each SiP chip a receptacle is attached, into which an FAU is configured to be inserted. In preferred configurations, a bridge structure (preferably manufactured from sheet metal) spans across all chips in a row and provides mechanical features to press the FAUs down into the receptacle and forward against a stop.

Other aspects of the embodiments disclosed herein pertain to a mechanical tool to allow a plurality of springs to be disengaged (preferably simultaneously) for insertion and removal of the FAU.

Advantages of the concepts disclosed herein, include, but are not limited to ease of manufacture, e.g. by providing one additional metal sheet part to realize mechanical support; providing an FAU that can be put in separately or removed; latching which can be accessed with a robot arm or manual operation, providing a sheet metal part with minimal need for high precision machining.

According to one aspect, a mechanism for co-packaged optics includes a FAU and a bridge structure having at least one spring configured to exert a force on the FAU. In preferred configurations, the bridge structure includes at least one lifter that facilitates disengagement of the at least one spring.

Holding mechanisms and assemblies for holding an FAU in a receptacle are also disclosed.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain the principles and operation of the various embodiments.

FIG. 1 schematically illustrates a datacenter switch with the ASIC in the center surrounded by 8 SiP optical modules on each side in accordance with embodiments disclosed herein;

FIG. 2 schematically illustrates a mechanism for holding an FAU in accordance with embodiments disclosed herein;

FIG. 3 is an isometric view of an assembly for holding an FAU in accordance with embodiments disclosed herein;

FIG. 4 is an isometric view of a mechanism for holding an FAU in accordance with embodiments disclosed herein;

FIG. 5 schematically illustrates a side view of a FAU in a receptacle in accordance with embodiments disclosed herein;

FIG. 6 schematically illustrates a top view of a FAU in a receptacle in accordance with embodiments disclosed herein;

FIG. 7 schematically illustrates a cross-sectional view of a FAU in a receptacle in accordance with embodiments disclosed herein;

The figures are not necessarily to scale. Like numbers used in the figures may be used to refer to like components. However, it will be understood that the use of a number to refer to a component in a given figure is not intended to limit the component in another figure labeled with the same number.

### DETAILED DESCRIPTION

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not limited to the described exemplary embodiments, but are to be controlled by the limitations set forth in the claims and any equivalents thereof.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

Cartesian coordinates may be used in some of the Figures for reference and are not intended to be limiting as to direction or orientation.

For purposes of description herein, the terms “upper,” “lower,” “right,” “left,” “rear,” “front,” “vertical,” “horizontal,” “top,” “bottom,” “side,” and derivatives thereof, shall relate to the disclosure as oriented with respect to the Cartesian coordinates in the corresponding Figure, unless stated otherwise. However, it is to be understood that the disclosure may assume various alternative orientations, except where expressly specified to the contrary.

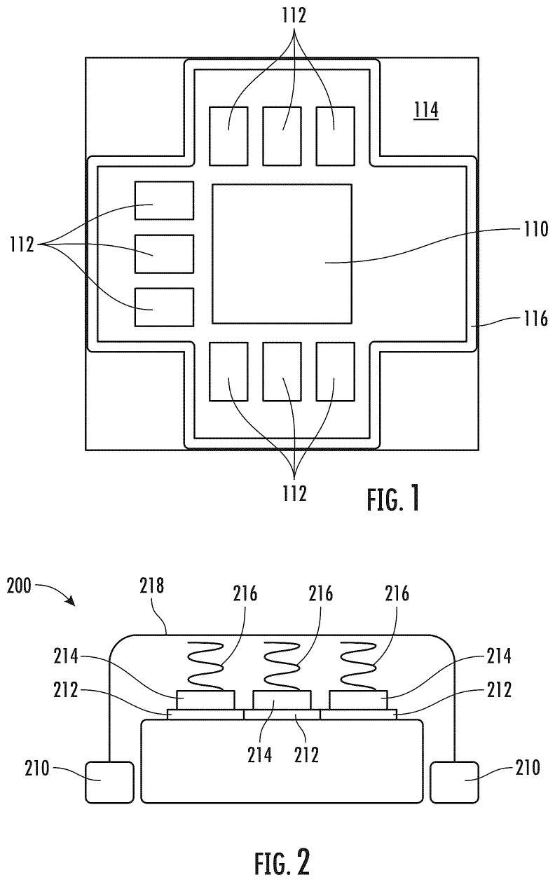

FIG. 1 schematically illustrates a datacenter switch assembly with an ASIC in the center surrounded by a plurality of optical modules, configured as SiP chips, on each side. The receptacle may be applied, for example, to datacenter switch ASICs. FIG. 1 schematically shows the layout of such a switch with the ASIC being mounted centrally on a printed circuit board (PCB) and surrounded by optical modules (SiP chips), which provide optical connectivity. In preferred configurations, the SiP chips are surrounded by a stiffener ring or another types of stiffening/stabilizing element to stabilize and reinforce the PCB.

In the corners of the assembly, heat sinks are mounted. Each of the plurality of optical modules have a size of about 6 mm width by about 5 mm length. The stiffener ring has a width of about 6 mm and a distance of about 10 to about 15 mm measured to the SiP chips.

The SiP chips provide optical coupling through near-vertical expanded optical beams. The optical connectivity to fibers is provided through the receptacles and fiber array units (FAUs) that include an optical turn (for example a prism) and a micro-lens array (MLA) to generate an expanded beam on the fiber side.

The receptacles are preferably permanently and/or integrally attached to the SiP chips and provide alignment for the FAUs. The concepts disclosed herein are configured to securely hold the FAUs in the receptacles such that a pluggable, i.e., re-matable optical link is established.

FIG. 2 schematically illustrates the bridge structure shown in FIG. 1. Here, the bridge structure is attached to the stiffener ring and spans multiple SiP chips. At the position of each chip the bridge structure has a feature that provides a downward force that holds the FAU securely in the receptacle.

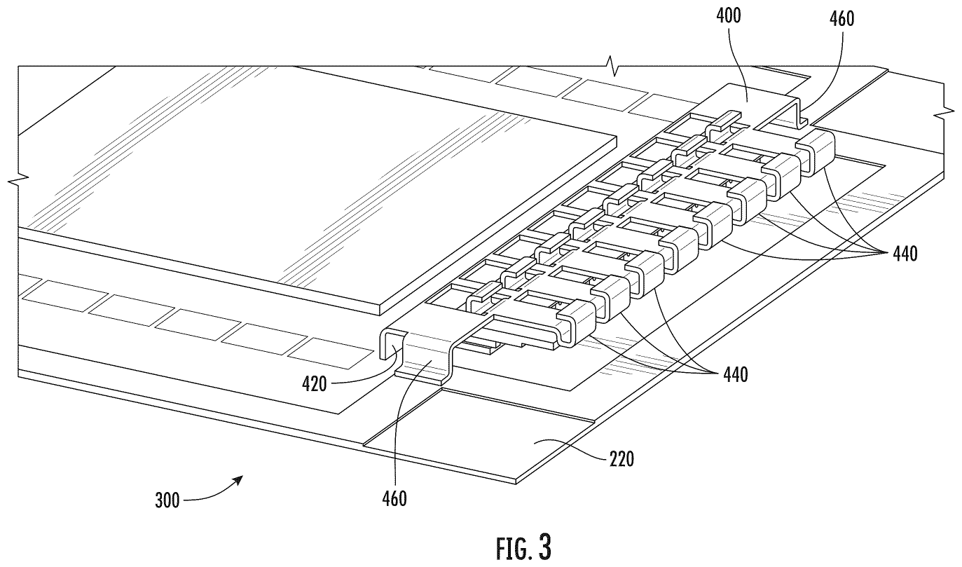

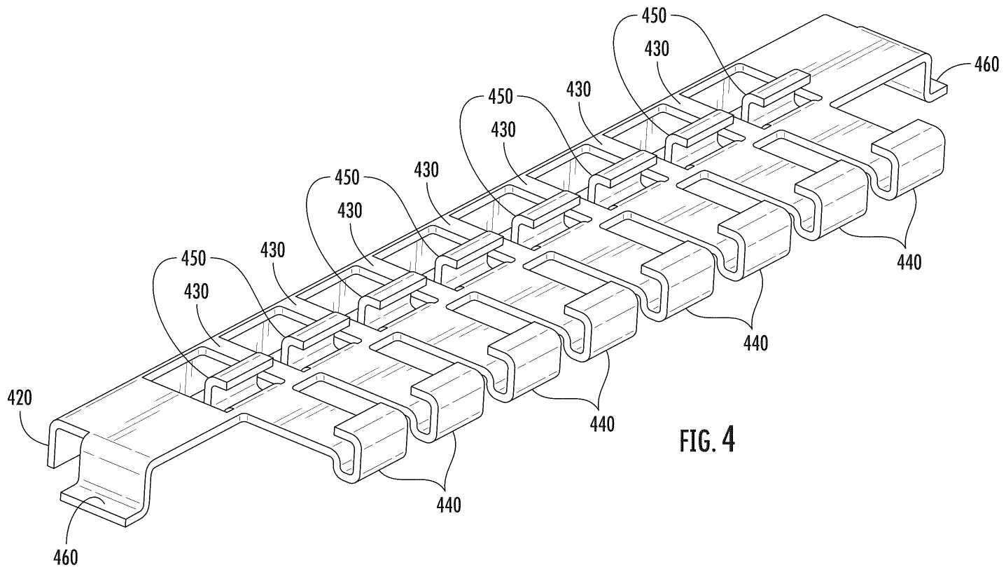

An embodiment of the bridge structure is shown in FIG. 3 and FIG. 4. It has features to be attached to the stiffener ring and a stiffening rip to prevent flexing along the length of the bridge structure.

At each SiP chip position, the bridge structure has two springs, one to provide a downward force to securely hold the FAU in the receptacle and one to provide a forward force along the direction of the alignment v-grooves to push the FAU against a stop to provide a defined position of the FAU.

Additionally, the bridge structure features lifters for the springs to easily disengage both springs.

FIG. 3 illustrates an embodiment of the bridge structure with a stiffening rip and two springs providing a downward and forward force.

FIG. 4 illustrates an alternative embodiment of the bridge structure. Here, a plurality of FAU is configured to be clamped individually and simultaneously. Each FAU can also be inserted and removed separately.

One embodiment of the bridge structure requires the bridge structure to be attached to the stiffener ring before the FAUs are inserted into the receptacle (shown here).

Another embodiment allows insertion of the FAUs in the receptacles first and acts as a cover to secure the FAUs. This requires additional receptacles to be installed on the stiffener ring, into which legs of the bridge structure are inserted and are locked into place. This simplifies the insertion of the FAUs into the receptacles, but allows a de-mating by lifting the springs of the bridge structure.

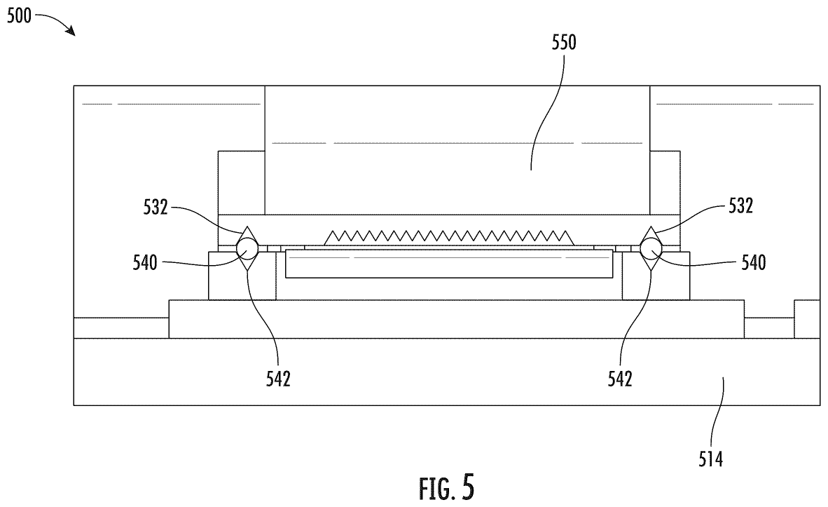

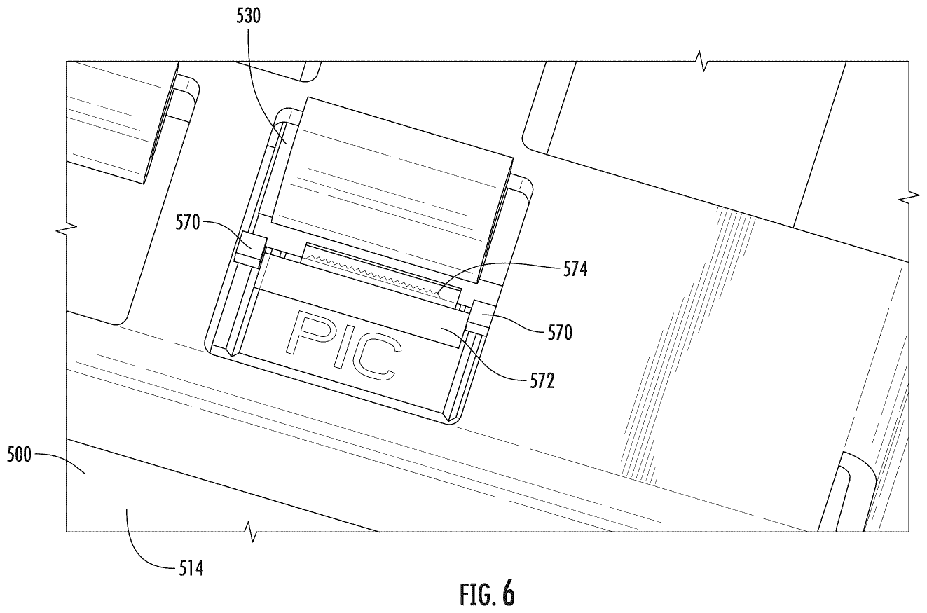

FIG. 5 and FIG. 6 show a rear-view and a top view of the bridge structure. In FIG. 6 the stops against which the FAU is pushed are pointed out.

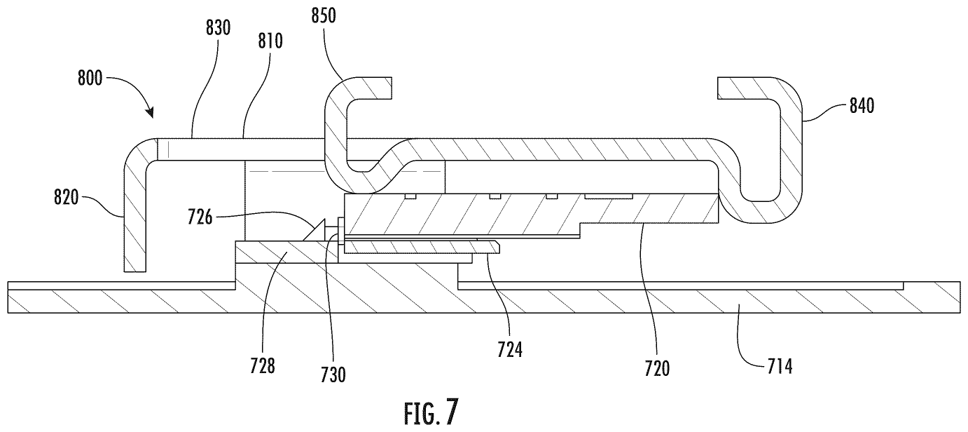

FIG. 7 shows a cross-section of the SiP chip, receptacle, FAU, and bridge structure. Here, the front spring is configured to push down the FAU and the back spring to push it forward and the lifters to disengage the springs.

Features included in the embodiments disclosed herein include: a bridge structure providing one or multiple springs for clamping an FAU into a receptacle providing a downward force and a forward force. In some configurations, the bridge structure is attached to the stiffener ring, the PCB, or any other suitable feature configured to close to the SiP chips.

Moreover, the springs may be released such that the connection is de-/re-matable; the bridge structure spans one or multiple SiP chips; the bridge structure features a stiffener rip that prevents flexing along the length of the bridge structure; the bridge structure features lifters for disengaging the springs. Additional features with respect to the lifting tool include the lifting tool complementing/fitting the bridge structure/spring/lifter geometry; lifting tool having a straight tab; lifting tool having multiple prongs in a tweezer-like arrangement; the tool has a tab for manual or machine lifting, and the tab may have a grommet, hook, or other feature for easy interacting with machine tool or robot fixture. The plurality of lifters may also feature holes or slots to engage with lifting tool. Finally, the lifting tool may also include pins that fit the holes on the lifters.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A mechanism for co-packaged optics, comprising:
an FAU; and
a bridge structure having at least one spring configured to exert a force on the FAU.

2. The mechanism of claim 1, wherein the bridge structure is coupled to a stiffening element.

3. The mechanism of claim 1, wherein the bridge structure is coupled to a PCB.

4. The mechanism of claim 1, wherein the at least one spring is dematable with the bridge structure.

5. The mechanism of claim 1, wherein the at least one spring is rematable with the bridge structure.

6. The mechanism of claim 1, wherein the bridge structure is configured to span across at least one SiP chip.

7. The mechanism of claim 1, wherein the bridge structure comprises a plurality of lifters configured to disengage the at least one spring.

8. The mechanism of claim 7, wherein the plurality of lifters is configured to engage with a lifting tool that engages with the bridge structure and facilitate disengagement of the at least one spring.

9. The mechanism of claim 1, wherein the bridge structure further comprises a stiffener rib configured to prevent flexing along the length of the bridge.
